(19) United States
(12) Patent Application Publication
(10) Pub. No.: US 2011/0073639 A1
(43) Pub. Date: Mar. 31, 2011

(54) METHOD AND APPARATUS FOR AN INTERACTIVE SHOPPING EXPERIENCE

(76) Inventors: Julie Robin Bartholomew, Birmingham, MI (US); Amy Green Deines, Livonia, MI (US); Angela Marie Brunetti, Scottsdale, AZ (US)

(21) Appl. No.: 12/841,973

(22) Filed: Jul. 22, 2010

Related U.S. Application Data
(60) Provisional application No. 61/227,553, filed on Jul. 22, 2009.

(51) Int. Cl. G06Q 30/00; G06F 17/00

(52) U.S. Cl. 235/375

(57) ABSTRACT

A method and apparatus for mining data about a customer from a customer's interactive shopping experience that not only assists the customer in their decision-making process, but also records the data in a manner that allows access to the data at a later time.

### CROSS REFERENCE

This application claims the benefit of the filing date of U.S. Provisional Application Ser. No. 61/227,553 filed Jul. 22, 2009, entitled “Method And Apparatus For An Interactive Shopping Experience” the entire disclosure of which is hereby incorporated by reference into the present disclosure.

### TECHNICAL FIELD

The inventive subject matter relates generally to a marketing system and method and more particularly, to a method and apparatus for an interactive shopping experience.

### BACKGROUND

Direct marketing typically involves advertising to customers at a location other than the point of sale. Targeted advertising is accomplished by assessing a predetermined customer profile and specifically addressing an advertisement to a customer who fits into a predetermined profile, be it age, demographic, or past purchase history and attempting to target a particular advertisement, through direct marketing, to the customer in such a way that the advertisement is relevant to the customer's profile. Goods and services are known to be promoted using newspapers, magazines, catalogs, first-class mail, e-mail, and telemarketing. And the Internet is an effective tool for tracking a consumer's inquiries in order to target advertisements to a particular customer profile. All of this marketing and advertising is directed to the customer at a point other than the point of sale and typically at a location remote from the retailer. Aside from the Internet, the messages are provided to the customer as a “pre-shopping” experience.

In addition to the pre-shopping experience advertising methods described above, advertisements placed within the retail environment are presented to customers, albeit in a very general and non-specific manner, typically without regard to the customer's profile. Further, many retailers have established practices that track and maintain a history of a customer's purchases within the store at the point of sale. This practice may even go so far as to link a particular sales associate with a customer's purchases in an attempt to target advertising to a customer by allowing the sales associate to contact a customer when in-store events will occur. However there is typically no information available to the associate, other than the customer's purchase history, to allow the retailer to determine which customers to invite to the in-store event.

There is a wealth of information available about the customer from their shopping habits and experiences that may be used to enhance the targeted advertising approach. However, the collection of this data is often overlooked during the period of time in which the customer is in the retail environment going through the shopping experience until the customer reaches the point of sale, thereby remaining an untapped resource for retailers.

For example, much valuable information may be gleaned from assessing the selections a customer chooses, samples, tries on, yet may not purchase. From the customer's perspective, it may be that they chose not to purchase an item simply because they are just not interested. However, it may also be that they are looking for another size, a similar style, a less expensive alternative, the prospect of a sale or discount, or they are just simply not able to make the purchase at that point in time and would like to return later. In any event, there is no record of the selection, samples, and reasons for or against the purchase.

From the customer's perspective, should they return to purchase an item at a later date, they have no way of accessing the information about the particulars of that product. From the sales associate's perspective, unless they take and retain copious notes about the customer and items they may have sampled but not purchased, they have no way of remembering each and every customer they assisted and each and every product that was offered to that customer, let alone the customer's opinion of or interest in a particular product. Additionally, the act of taking notes may be impractical for a sales associate as they are typically servicing more than one customer at a time. Further, retaining and referencing any notes taken by sales associates is laborious and would require extreme organization and neatness on the part of the sales associate. Still further there is the drawback that one sales associate's notes for a particular customer may not be accessible by another sales associate who may be helping the same customer at another point in time or on a different day. Cross referencing an associate's personal, handwritten notes would also prove to be a daunting task.

There is a need to establish and develop an evolving customer profile that results in relevant and cost effective advertising to an individual customer based on their profile. There is a need for collecting, accessing and analyzing data from a “shopping experience” in a meaningful way that benefits not only the customer, but the sales associates, the brand owners, and ultimately the retailer. There is a need to raise the level of customer service within the retail environment to a point that will help a retailer or a brand owner retain a customer's loyalty and thereby increase sales.

### SUMMARY

The inventive subject matter provides a method and apparatus for mining data about a customer from a customer's interactive shopping experience that not only assists the customer in their decision-making process, but also records the data in a manner that allows access to the data at a later time. The method and apparatus comprising the combination of features of the independent claims, preferred optional features being introduced by the dependent claims.

### DESCRIPTION OF DRAWINGS

FIG. 1 is a block diagram of the interactive apparatus of the inventive subject matter;

FIG. 2 is a flow diagram of the method of using the interactive apparatus of the inventive subject matter; and

FIG. 3 is a flow diagram of a reporting method of the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

The present invention is being described herein in a retail environment, such as a department store. Further, the inventive subject matter is being described herein with reference to a cosmetics department. However, it should be noted that one of ordinary skill in the art is capable of applying the inventive subject matter to any type or arrangement of an in-store shopping experience, and any product. For example, the inventive subject matter may be easily applied to a drug store or home improvement store setting and may apply to products such as clothing, house wares, power tools, luggage, etc.

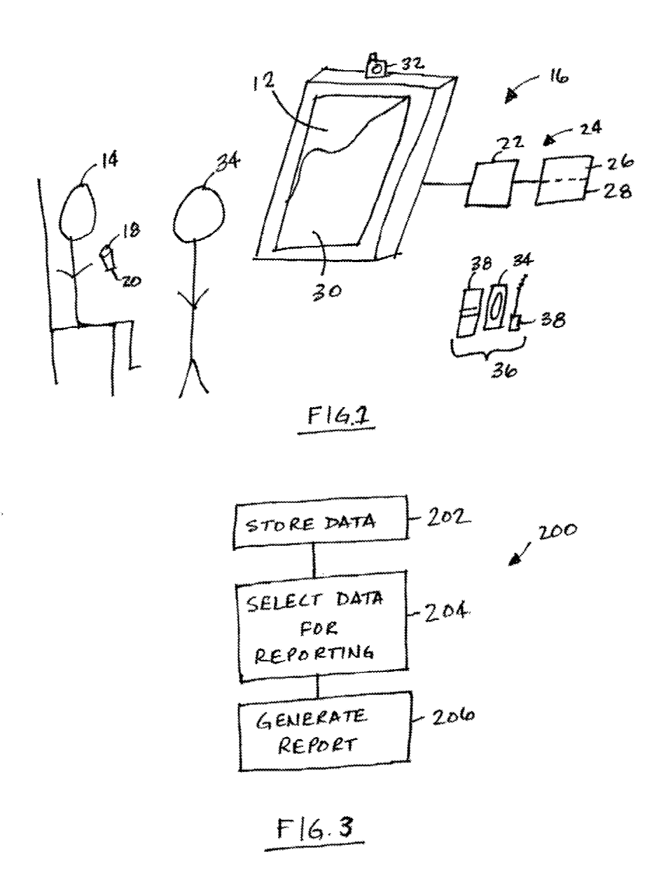

Referring to FIG. 1, there is shown an interactive apparatus 10 that may have a reflective surface 12 that is available for use while a user 14, such as a customer 15, is shopping within a retail environment 16. The user 14, which is the customer 15 and/or a sales associate 34, may have an identifier device 18, such as key fob or a USB device that associates a unique identifier code 20, such as an RFID code to the user 14, i.e., the customer and the sales associate respectively, and at the same time may link the customer to the sales associate and to the particular shopping experience. The apparatus 10 has a reader 22, such as an RFID reader, configured therein so as to identify the user 14 and relate the customer and the sales associate to the shopping experience that is taking place. The user 14 approaches the apparatus 10, the reader 22 senses the identifier device 18 thereby associating the customer to the shopping experience. When not in use, the apparatus is in a “sleep mode”. In one embodiment, the reflective surface 12 appears to be simply a mirror when the apparatus 10 is not in use. Upon activation through touch or recognition of an identifier device 18, the apparatus 10 become active and available for interactive use.

A controller 24 is associated with the apparatus 10. The controller 24 may be a computer. The controller 24 has a microprocessor 26 and memory 28 associated therewith. The controller 24 is adapted to send and receive information to a display 30, such as a monitor. The information may be output as images, in the form of icons and/or video, visible to the customer and selectable by the user 14.

In one embodiment the controller 24 has a touch screen device, such as a monitor 30, a terminal, or some combination thereof, that is located beneath the reflective surface 12. Images, such as icons or photographs, are displayed and accessed by touch, through the reflective surface 12, on the monitor 30. As images of particular products are displayed, they may be selected or ignored. In either event, the microprocessor is collecting the data associated with the customer, the products, and their selection or lack of selection by the customer.

In another embodiment, the apparatus 10 has a recording device 32, such as a camera, therein for capturing image data and/or video of the customer and the customer's shopping experience in real time. The camera is visible in the figure for example purposes only. It may be integrated into the apparatus 10 as part of the display 30 or controller 24 so that it is capturing images yet is not fully visible on or within the apparatus 10. Image data is stored and may be accessed by the customer on-demand at any point in time. The access may be at a computer 30 within the retail environment or at a location remote from the retail environment, such as a customer's home computer (not shown). The image data may also be transmitted to a location selected by the user 14 such as an email address, a mobile telephone. The user 14, preferably the customer, may select to transmit and publish selected image data to their social network, such as MySpace or Facebook.

Applying the present invention to an example of a shopping experience within the cosmetics department of a retail environment, the user is defined as a customer 15 and a sales associate 34. A customer 15 may approach a sales associate 34 for assistance with purchasing products, such as cosmetics. The sales associate 34 may identify the customer 15 and access a customer profile in the controller 24. In the alternative, the RFID reader 22 may identify the customer by sensing the customer's identifier 20 and accessing the customer profile in the controller 24. In any event, the customer has a profile 32 that is associated with the customer identifier 18 and displayed at the apparatus 10 and accessible by both the customer and the sales associate. A new or first-time customer 15 may be assisted in creating a customer profile that is linked to the identifier 18 and assigned a unique identifier 20. The apparatus 10 appears to be a mirror when it is not activated. Upon activation the interactive experience begins and the images are presented for selection by the user 14.

As part of the shopping experience, the sales associate may present one or more products 36 for review and sampling by the customer 15. Product samples 36 being presented to the customer 15 may also be equipped with their own unique identifiers 38, such as RFID tags, linking the products UPC to a unique RFID. The product's unique identifier 38 may be read by the reader 22 in the apparatus 10. Upon recognition of the identifiers 38, the processor 24 will equate the unique identifier 38 associated with the tagged product 36, access data about the product that is stored in memory 26, and display the product data. The apparatus 10 may display data in the form of an image, such as an icon, photograph or video stream, which may also incorporate audio. The data displayed represents the particular product. This will occur consecutively for each selected or tagged product sample 34 that is presented to the reader 22 by either the customer 15 or the sales associate 34. In the alternative, the apparatus 10 may present a method for selecting a product, such as by name or type or product through a keyboard or image of a keyboard on the apparatus. The customer 15 or sales associate 34 may then select a product by name for review at the apparatus without the need for a tagged product to be near the reader.

As the customer 15, or sales associate 34 selects or waves each tagged product 36 for review, information is simultaneously being displayed and collected by the microprocessor 24 in the form of automated and prompted data collection methods. For example, the customer 15 may sample three different shades of lip gloss. As each sample is identified at the reader or selected at the apparatus 10, and product information is displayed as static photos, streaming video, media clips, printed article excerpts. Unique information about the product such as special ingredients, and any other information may be displayed and revealed through the mirrored surface 12 of the apparatus 10.

The identified and/or selected product data is associated with the customer profile and is stored in memory 28 for access by the customer 15, the sales associate 34, the product vendor or the retailer. Should the customer 15 opt to purchase any of the products sampled, the sales associate may select the item for purchase, through prompts presented by the controller on the display that are associated with each aspect of the shopping experience. Once an item has been associated with the customer's profile, it is stored. Upon point of sale purchase, the information about the product is readily available to the sales associate and is already associated with the customer's profile, thereby expediting completion of the sale. This process is repeated for each product 36 sampled and/or purchased.

As explained above, the apparatus 10 may have a camera 32, or other recording device, therein for collecting image data of the customer and the customer's shopping experience in real time. The image data may be stored and may be reviewed at any time during the shopping experience. The camera may record video or images of the sales associate 34 applying the cosmetics to the customer 15. The camera may also record any step in the make-over process upon demand by either the customer 15 or the sales associate 34. The images may be reviewed on the spot, or they may be stored for access at a future date. In this regard, the customer is able to relax and enjoy the shopping experience without worrying about having to remember each and every detail associated with the products sampled and the instructions provided by the sales associate. In another embodiment, the images may be edited by the sales associate or the customer. The customer 15 may choose to transmit selected images to email, mobile telephone, or social network to save the data, review the data, or share the image data with friends and/or family.

The apparatus will record the history of the shopping experience, capturing data pertinent to each of the products sampled during the shopping experience, each of the products purchased upon completion of the shopping experience, as well as information about how they are to be applied and in what order. Because the shopping experience is stored in association with the customer profile and is linked to the sales associate, the information is accessible by the customer, sales associate, vendor and retailer in a manner similar to the sample history and purchase history. This is particularly advantageous because a customer may not purchase all of the products used during the shopping experience and will have the ability to access the information at a later date. Stored information may be forwarded to a social networking site, itouch/iphone or other mobile device application, email, cell phone, text message, Twitter, website, brand owner's website, etc.

The apparatus 10 will have linked the customer, the sales associate, the shopping experience, and any sale in such a way that it may generate an automated prompt for the sales associate to draft a thank-you note to the customer. In the alternative, the system may generate an automated thank-you note on behalf of the sales associate that is automatically sent off to the customer. The customer may receive the thank-you note by way of regular mail, email, a text message, or a post on a website or other social network such as MySpace or Facebook. Furthermore, the customer profile may specifically identify the manner in which the customer chooses to be contacted, if at all.

At a later point in time, such as on a return visit, the customer may inquire about purchasing a particular product they sampled during their previous shopping experience. The customer may not be as familiar with the products as a sales associate, and so they may not remember the brand or shade of product. The sales associates will likely have assisted many other customers since serving the customer seeking the product and without a written record would be hard pressed to remember each and every product sampled on each and every customer. In the absence of hand-written notes from the previous session, the sales associate has no way of retrieving the information for that particular customer as it relates to that particular shopping experience. Using the present invention, because the historical information has been stored, whether the products were purchased or not, it is readily accessible by the customer or sales associate.

Retrieval of stored information begins with identification of the customer using the identifier at either the apparatus or by way of a secure website using a mobile device or a computer remotely located from the retail environment. The customer and/or sales associate may use their identifier device at the interactive apparatus or at a point-of-sale terminal. Only the unique identifier is stored on the identifier device, which may be a key fob device. The unique identifier links the stored data to a particular customer and all personal customer information is stored separate and distinct from the key fob and data collection system. For security purposes, there may be no, or limited, access to personal, credit card, or other sensitive information relative to the customer's profile stored on the key fob or the data collection apparatus.

Storage of the collected data may be at individual sites, networked among all stations at a particular site, or networked among all stations across all sites. The data may also have a limited life in that after a predetermined period of time the data is eliminated from storage in order to save memory space. As described above, access to the stored data is safe and secure. Images may be deleted after a predetermined period of time or upon demand by an authorized user.

A method of the inventive subject matter will also be described herein with reference to a customer experience within a cosmetics department of a retailer. As explained above, the inventive subject matter is applicable to any one of many customer experiences and one skilled in the art is capable of translating the method to other stores and products without departing from the scope of the present invention. According to the method 100, a customer is assigned 102 a unique identifier, such as an RFID, that relates the particular customer to their customer profile. The assignment may be acquired on-site at the store from a sales associate. In one embodiment, the customer is given, or purchases, a key fob that contains their unique identifier and that is capable of being read by a reader in order to recognize and identify the customer, as well as link the shopping experience and the data obtained there from to the customer's evolving profile. The sales associate likewise is assigned and/or has 104 their own unique code, or identifier, as well. As described above, the unique identifier may be an RFID code that is stored on the identifier device associated with a particular user.

Each shopping experience for a customer will be linked 106 to the customer and/or a particular sales associate at the time the experience is initiated. The order of identification for the customer and/or the sales associate is not a concern and may occur in any order. For example, the customer may swipe their RFID fob in front of the reader, thereby identifying the customer and the sales associate may then swipe their identifier, or vice-versa. In either order, there is a link established 106 between the customer, the sales associate and the particular shopping experience. The apparatus may capture 108 time and date information for reference purposes in the database.

The sales associate proceeds to select particular products for sampling by the customer either through their suggestions, the customer's request, or suggested samples provided by the product vendors. The selections are stored 110 in the database and linked 112 to the shopping experience. Once products are selected, information is presented 114 to the customer and the sales associate by way of the interactive device. The information may be text, pictures, video, or other streamed data. The data may be educational, entertaining, or a combination of both. The content may include promotions, sales and advertising directly targeted to the customer profile associated with the shopping experience.

Once the product has been selected and the data has been presented, the sales associate may initiate 116 the camera device to record the application of the product to the customer. The camera may be initiated upon command by the sales associate, or it may automatically snap shots of the application at predetermined intervals. In the alternative, a video is taken. The start and end time may be automated or may be controlled by the sales associate.

Upon completion of the application, the sales associate will proceed with any other products the customer may be interested in, or the customer may designate 118 the product status as it relates to their profile. The product designation may be that the customer has selected the product for purchase. The customer may designate the product to a wish list, as a preference, as a like or a dislike for example. in any event, the information that the customer uses to designate the product is stored to the customer profile. At the same time, the product information is stored for the vendor and the retailer, such that they may access the data associated with that particular product, that particular customer and that particular sales associate in such a way that a meaningful report may be generated by the retailer, vendor, sales associate or customer as they request data from the shopping experience.

Upon completion of the shopping experience, the items selected for purchase by the customer may be communicated 120 to the retailer's point of sale system so that the purchase by the customer is expedited. At the point of sale, the sales associate may select to generate 122 a thank-you note. The sales associate may choose to send an automated thank-you note, or may draft a personal thank-you note that is communicated to the customer in the manner chosen as a preference by the customer in their evolving profile.

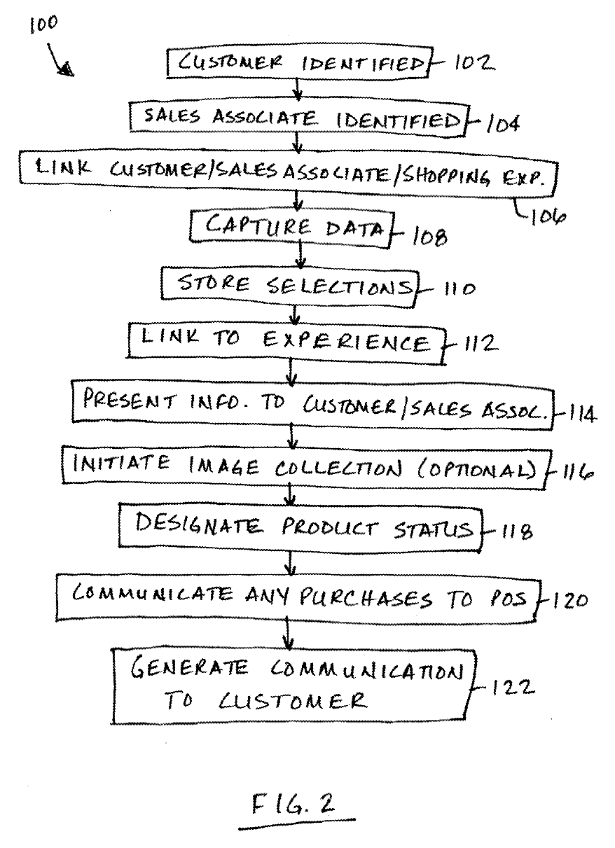

A data report may be associated with the data collected from the method shown in FIG. 2. The data that was collected during the shopping experience and linked to the customer and the sales associate is available for reporting to the customer, the sales associate, the vendor and the retailer according to their demand. Their preferences, any requested information relating to sales, sampled items, customer data, may be selected and reported by the apparatus. The database storage is such that the information linked to the customers, sales associates and vendors is accessible as desired by any requesting party. Data pointers may be used to sort data that has been selected for reporting. The report is generated and presented in a format that presents the report information in a meaningful way.

According to the inventive subject matter, the valuable data collected during the shopping experience and linked to customer, sales associate and vendor may be used by the requesting party in a variety of ways. For example, a customer may inquire about a particular product sampled, but not purchased during a prior shopping experience. A sales associate may inquire about a particular customer's preferences in order to select samples for a current shopping experience. A sales associate may also want to follow-up with a customer from a prior shopping experience regarding samples that they were interested in yet had not purchased, possibly offering an incentive or notification of an upcoming sales promotion.

The vendor may inquire about particular products and compare sampled products with purchased products. In the event the sales associate entered any customer comments and or information about a particular product, the vendor may have access to that data as well and may use it to improve a product, its price point, or its availability.

The retailer may inquire about a particular customer, a particular sales associate, or compare vendor sales. For example, the retailer may determine through comparison the stored data, which vendor products s are being sampled and which vendor products are being purchased.

The reporting combinations are virtually limitless and are dependent only upon the data gathered and stored during the shopping experience. Because the shopping experience, the customer, sales associate and products sampled are all linked, the data is extremely useful and relevant for the purposes of targeted advertising.

In an alternative embodiment to the method, a link may be provided at the apparatus so that a customer may select a particular charity. The apparatus may display information about the selected charity and accept donations to the charity.

In yet another alternative embodiment, the apparatus may present a barcode image, or a tag may be provided on the product sample itself. The barcode image is photographed by the user using a mobile device and links the user to a website that provides information about a product, charity, or event that is associated with the photographed barcode image. The user is directed to a website containing content associated with the selection that may be in the form of images, video, text or other content. The link is another facet of the interactive shopping experience of the present invention.

An advantage of the inventive subject matter is that the customer's profile is evolving and is being updated with each shopping experience. The customer is able to maintain their own record of products purchased, sampled, liked, disliked, etc. so that they can access the information upon demand using their unique identifier. Another advantage is that the retailer may mine data from the customer's profile so that the customer may be targeted with specific promotions and advertisements that are relevant to them based on the data in their profile, such as age, demographic, and preferences, not only from past purchases, but from past shopping experiences.

The sales associate has a profile that evolves along with the profiles of their customers that enhances the customer experience by allowing the sales associate to become familiar with their customers and they are better able to assist the customer while they are in the retail environment. Further, it is possible that more than one sales associate may be connected with the same customer. In the event there is overlap among sales associates with a single customer, the method of the inventive subject matter will rate the sales associates in a rank, or order, so that communication or contact with a customer is not duplicated among several sales associates. For example, an in-store event may be assigned to a particular sales associate for a particular customer so as to avoid multiple notifications to a single customer about the event. A further advantage is that the sales associates evolving profile may be viewed by managers in order to assess performance and possibly implement incentives and or training notifications.

The vendors are able to track product performance. Obviously, product sales are easily tracked and identified. However, the present invention presents a unique advantage for retailers and vendors in that they are able to asses products that were sampled, but not purchased and evaluate the reasons behind the customer's decisions. This aspect will promote customer loyalty, improved customer service and possibly even promote product improvement.

The data collected during the customer's shopping experience may be used to target promotional events to customers in a relevant manner so that advertising dollars are being spent efficiently and with the greatest possible return on investment.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

What is claimed is:

1. An apparatus for an interactive shopping experience, the apparatus comprising:
a controller having a processor, memory and communication capability;
a monitor having a reflective surface, the monitor in communication with the controller;
an RFID reader in communication with the controller and at least one RFID tag within a predetermined proximity to the reader;
a camera in communication with the controller; and
the at least one RFID reader reads the at least one RFID tag and initiates the controller to begin an interactive shopping experience that is displayed on the monitor, with predetermined moments captured by the camera, the interactive shopping experience being monitored by the processor and selected events, products, customer comments will be associated with the at least one RFID tag, stored in memory or shared via the communication capability.

2. A method for data mining an interactive shopping experience using an apparatus comprising a controller having a processor, memory and communication capability, a monitor having a reflective surface, the monitor in communication with the controller, an RFID reader in communication with the controller and at least one RFID tag within a predetermined proximity to the reader, and a camera in communication with the controller, the method comprising the steps of:
identifying a customer or product associated with the RFID tag;
displaying data associated with the at least one RFID tag;
recording data associated with the at least one RFID tag and the interactive shopping experience; and
storing data associated with the at least one RFID tag.
